(19) United States
(12) Patent Application Publication
(10) Pub. No.: US 2002/0010572 A1
(43) Pub. Date: Jan. 24, 2002

(54) Integrated system for and method of supporting spatial decision making and land-use scenario analysis

(76) Inventors: Lyman Orton, Steamboat Springs, CO (US); Noel Fritzinger, Weston, VT (US); Brenda Faber, Loveland, CO (US)

Correspondence Address: PENNIE AND EDMONDS, 1155 AVENUE OF THE AMERICAS, NEW YORK, NY, 100362711

(21) Appl. No.: 09/836,618

(22) Filed: Apr. 16, 2001

Related U.S. Application Data
(60) Provisional application No. 60/197,427, filed on Apr. 14, 2000.

(51) Int. Cl. G06F 9/45

(52) U.S. Cl. 703/22

(57) ABSTRACT

The present invention is an integrated system for and method of supporting multi-objective spatial decision-making and land-use scenario analysis. In a preferred method embodiment, the present invention comprises a method of providing a fully interactive and integrated planning tool in an integrated software suite for spatial decision making comprising spatial decision-making and land-use planning software modules wherein modifications made to land-use scenarios in one software module are immediately reflected in other modules. In a system embodiment the invention comprises an integrated softwarebased system for spatial decision making comprising a common spatial database, a clearinghouse hub; and a plurality of spatial decision-making and land-use planning software modules.

### CROSS-REFERENCE TO RELATED APPLICATIONS

This application claims the benefit of U.S. Provisional Application No. 60/197,427, filed Apr. 14, 2000.

### BACKGROUND

Land-use planning has historically been a linear process in which land-use scenarios are created, considered, and then abandoned or implemented depending on the viability of the resulting scenario. This is a time-consuming, subjective, and reductive process that does not completely consider many important land-use factors because it is extremely difficult for a human analyst to generate, retain, and consider multiple scenarios in a short enough period of time to make a meaningful decision about a particular land-use issue.

Roughly fifteen to twenty years ago, Geographical Information System (GIS) software spatial tools made their entrance into the field of land-use planning, forever changing the way land-use planning is conducted. A GIS is an information system that is designed to work with data referenced by spatial or geographic coordinates. A GIS is both a database system with specific capabilities for spatially-referenced data, as well as a set of operations for working with the data. GIS color-coded maps and spatial analysis tools considerably simplified scenario analysis processes but, unfortunately, did not alter the fundamental nature of how scenario analysis was conducted; it still remained a linear and one-way process of reduction, which severely limits the variety of alternatives land-use planners have available to consider. This leads to inaccurate land-use forecasts, poorly imagined scenario alternatives, and potentially detrimental land-use plans. While a number of software tools have been introduced that attempt to address this issue, none work in an integrated fashion such that multiple land-use scenarios and factors can be modified and considered with near-simultaneity.

For example, U.S. Pat. No. 5,818,737, “Method for guiding development of municipality,” to Orr et al., describes a method for creating an electronic general plan for a municipality that is capable of providing projected results and effects based upon varying the inputted data as a function of the consequences of presently made or proposed decisions by the decision makers of the municipality. A series of software modules utilize the data for a series of specific applications defined by the municipality. The output provided by modeling and simulation modules may be in the form of two- or three-dimensional visual presentations. Other patents that use GIS or related technology include U.S. Pat. Nos. 5,835,386; 5,831,876; 5,818,737; 5,815,417; 5,808,916; 5,784,540; 5,671,381; 5,652,717; 5,555,354; 5,528,735; 5,193,185; and 4,969,114.

Land-use planning has traditionally been a linear and reductive process in which a restricted number of objectives can be considered due to the fact that only a small inventory of conditions, variables, parameters, and alternatives can be processed at a time. As the above-referenced patents demonstrate, the linearity problem persists. This has led to largely subjective side-by-side comparison of land-use scenarios and the adoption of less-than-optimal land-use solutions. Thus there is a need for a way to perform multi-objective land-use planning.

To devise optimal land-use plans, municipalities must consider a multitude of factors ranging from present and predicted growth patterns to resource availability thresholds to socioeconomic demographics, to name only a few. The consideration of such a wide array of factors requires extremely flexible software applications that can approach land-use analysis from analytical, visual, and predictive perspectives. While specialized applications exist for these types of tasks (see the above-referenced patents), they are often too limited in their scope to accommodate all types of analysis. This circumstance of limited tool flexibility leads land-use planners to make important decisions based on a restricted set of variables and assumptions. Thus there is a need for a way to integrate the analytical, visual and predictive evaluation of land-use scenarios.

Complete visualization of land-use scenarios is a key factor in understanding the real-world impact of those scenarios. Unfortunately, most existing land-use planning applications are unable to completely visualize land-use scenarios, much less integrate a visualization capability with other land-use planning tools. This has led to inefficient planning processes and ill-considered land-use plans. Thus there is a need for a way to perform land-use planning with integrated visualization.

In order for land-use planners to gain a complete understanding of how current decisions will impact future land-use directions, they must be able to forecast future development patterns, such as population growth, traffic volumes, and housing density. While forecasting models exist, they are not presently integrated with applications that consider a wider range of land-use factors, and are therefore limited in their accuracy and usefulness. Thus there is a need for a way to better understand the future impacts of current decisions in land-use planning.

The consideration of a wide range of variables, conditions, relationships, and parameters is critical to the development of an optimal land-use strategy. Unfortunately, conventional land-use planning tools that are specialized in function allow the consideration and modification of a restricted number of variables and parameters. This results in the consideration of a limited number of land-use alternatives and, as a result, the selection of less-than-optimal land-use solutions. Thus there is a need for a way to provide the freedom to change any land-use planning variable or parameter.

Land-use planning processes have traditionally been laborious procedures in which a skilled technician may take days or even weeks to analyze potential impacts of alternatives. This has limited the amount of interaction that land-use planners have had in the land-use planning process, resulting in the less-than-ideal selection of land-use alternatives. The adoption of GIS tools has remedied this situation to some extent, but the process remains largely a one-way, reductive procedure in which real-time interaction is difficult, if not impossible. Thus there is a need for a way to interactively perform land-use planning in real-time.

Because land-use planners must often consider multiple scenario alternatives within a short period of time, the ability to perform land-use planning processes quickly and efficiently is critical to the success and adoption of an eventual solution. Unfortunately, conventional procedures for scenario analysis typically take days or weeks to conduct, severely restricting the number of scenarios that can reasonably be reviewed. Thus there is a need for a way to perform land-use planning rapidly.

### SUMMARY

The present invention addresses the above needs, and further provides the following advantages over the above-cited references: (1) the invention provides multi-objective land-use planning capabilities; (2) the invention enables users to interactively perform land-use planning in real-time; and (3) the invention integrates analytical, visual, and predictive evaluation of land-use scenarios.

Other advantages provided by the present invention include: (1) it provides a way to perform land-use planning with integrated visualization; (2) it provides the freedom to change any land-use planning variables or parameter; (3) it provides a way to perform land-use planning rapidly; and (4) it provides a way to better understand the future impacts of current decisions in land-use planning.

In a first aspect, the present invention comprises an integrated system for supporting spatial decision-making and land-use scenario analysis, preferably including: (1) a main unit that includes (a) a RAM device: (b) one or more CPUs; (c) a hard disk drive that stores (i) an operating system; (ii) a spatial database; (iii) third-party applications; and (iv) a preferred integrated software suite for spatial decision making (referred to herein as “Integrated Software Suite”); and (d) a high-speed graphics card; (2) a CD-ROM drive; (3) a high-resolution display; (4) a keyboard; and (5) a mouse.

In a second aspect, the present invention comprises software based on a topology for supporting spatial decision-making and land-use scenario analysis, including and integrating the following software: a 3D Visualization Module, further including a Model Library; a Desktop GIS, further including an Impact Analysis Module; and a Forecasting Module. This software is discussed in greater detail below.

In a third aspect, the present invention comprises an integrated method of supporting spatial decision-making and land-use scenario analysis, including the steps of: (a) installing Integrated Software Suite applications, including a Desktop GIS; (b) loading Integrated Software Suite extensions into the Desktop GIS; (c) creating a scenario view; (d) loading spatial data; (e) selecting an application; (f) determining whether appropriate impacts-modeling framework definitions exist; (g) determining whether appropriate terrain specifications exist; (h) determining whether a forecasting model is parametrized and calibrated appropriately; (i) defining an impacts- modeling framework; (o) experimenting with scenario alternatives and monitoring impacts; (k) specifying the terrain, draping an image and adding 3D features; (1) visualizing, modifying, and walking through scenario alternatives in 3D; (m) parametrizing and calibrating a forecasting model; (n) forecasting long-term implications of alternative scenarios and experimenting with policy options; (o) determining whether to save a scenario for future reference; (p) saving the scenario; and (q) determining whether to continue exploring scenarios.

In a fourth aspect, the present invention comprises a method that provides real-time integration of spatial decision-making and land-use scenario software modules, comprising the steps of: (a) receiving a scenario data modification from a first module of an integrated software suite for spatial decision making; (b) recording the scenario data modification in a spatial database; and (c) alerting other modules of the software suite of the scenario data modification.

In a fifth aspect, the present invention comprises a method of providing a fully interactive and integrated planning tool in an integrated software suite for spatial decision making comprising spatial decision-making and land-use planning software modules wherein modifications made to land-use scenarios in one software module are immediately reflected in other modules, comprising the steps of: (a) enabling each module in the software suite to record each scenario data modification performed by that module in a common spatial database; (b) creating a clearinghouse hub that is capable of receiving notifications of scenario data modifications from each module and of immediately notifying all other modules of each scenario data modification; (c) enabling each module to immediately inform the clearinghouse hub of each scenario data modification performed by that module; and (d) enabling each module to respond to each notification of a scenario data modification received from the clearinghouse hub by immediately accessing the modified scenario data in the common spatial database.

In a sixth aspect, the present invention comprises an integrated software-based system for spatial decision making comprising: (a) a common spatial database; (b) a clearinghouse hub; and (c) a plurality of spatial decision-making and land-use planning software modules, wherein each module is operative to record in the common spatial database each scenario data modification performed by that module and operative to immediately inform the clearinghouse hub of each scenario data modification performed by that module; wherein the clearinghouse hub is operative to receive notifications of scenario data modifications from each of the modules and to immediately notify all other of the modules of each scenario data modification; and wherein each module is operative to respond to each notification of a scenario data modification received from the clearinghouse hub by immediately accessing the modified scenario data in the common spatial database.

### BRIEF DESCRIPTION OF THE DRAWINGS

FIG. 1 is a diagram of a personal computer (“PC”) used in a preferred embodiment for supporting spatial decision-making and land-use scenario analysis

FIG. 2 depicts software topology for supporting spatial decision-making and land-use scenario analysis.

FIG. 3 illustrates steps of a preferred integrated method of supporting spatial decision-making and land-use scenario analysis.

FIG. 4 illustrates steps of a preferred method that provides real-time integration of spatial decision-making and land-use-scenario software modules.

### DETAILED DESCRIPTION OF PREFERRED EMBODIMENTS

The present invention comprises an integrated system for and method of supporting spatial decision-making and land-use scenario analysis. The integrated method utilizes a software suite to conduct a real-time analytical, visual, and predictive evaluation of land-use scenarios. Modifications made to land-use scenarios in one software module are immediately reflected in other modules via a common spatial database, providing a fully interactive and integrated planning tool.

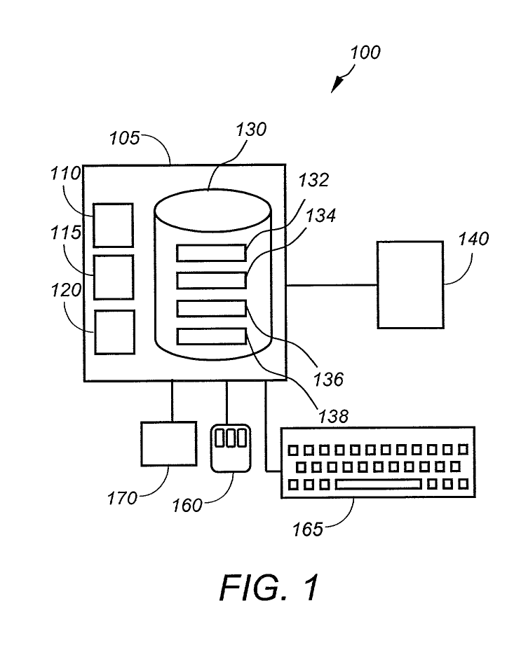

FIG. 1 illustrates a PC 100 used for supporting spatial decision-making and land-use scenario analysis. PC 100 includes a main unit 105, a high-resolution display 140, a mouse 160, a keyboard 165, and a CD-ROM drive 170. Main unit 105 further includes one or more CPUs 110, RAM 115, a high-speed graphics card 120, and a hard disk drive 130. Hard disk drive 130 stores an operating system 132, a spatial database 134, third-party applications 136, and Integrated Software Suite 138.

Operating system 132 is preferably a commercially available operating system like Windows NT. Third-party applications 136 include commercially available GIS analysis and rendering programs, including, for example, such Desktop GIS products as ESRI's ArcView. Integrated Software Suite 138 preferably includes an Impact Analysis Module, a 3D Visualization Module, and a Forecasting Module (although more, or fewer, modules could be included). These modules are described in greater detail below.

High-speed graphics card 120 is preferably an ultrahigh-speed graphics card using OpenGL, for 3D rendering. High-resolution display 170 supports third-party applications 136, which are generally heavily graphic in nature, and is electrically connected to main unit 105. Also electrically connected to main unit 105 are mouse 160, keyboard 165, and CD-ROM drive 170.

In operation, third-party applications 136 and Integrated Software Suite 138 are installed on hard disk drive 130. A user creates a scenario view using keyboard 165, mouse 160, and available data. The user then enters spatial data via keyboard 165, CD-ROM drive 170, or another data source, and spatial database 134 is updated accordingly. The user then defines a modeling framework using the separate modules of Integrated Software Suite 138, creates various land-use planning scenarios, and views the visual results of these scenarios on high-resolution display 140. Because of the integrated nature of Integrated Software Suite 138, a change in any of the separate modules of Integrated Software Suite 138 is reflected in the other modules. As the user experiments with different scenarios, visualizes scenario alternatives, and forecasts long-term implications of scenario alternatives, spatial database 134 is continually updated to reflect the changes in the data.

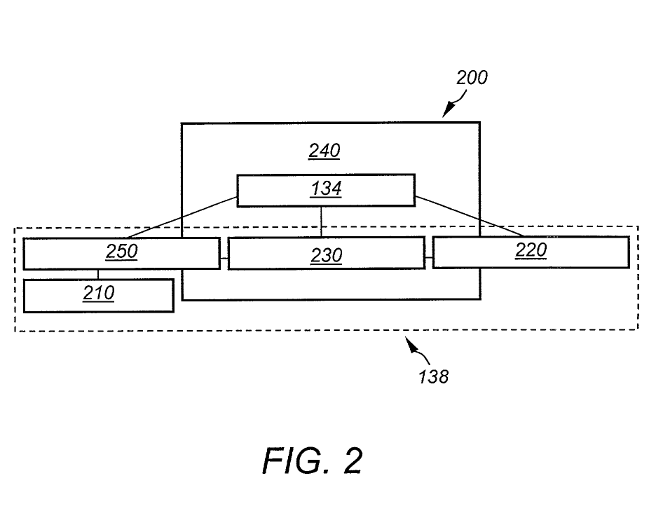

FIG. 2 illustrates a software topology 200 used for supporting spatial decision-making and land-use scenario analysis. Topology 200 includes Integrated Software Suite 138 interfacing with Desktop GIS 240. Desktop GIS 240 further includes spatial database 134. Integrated Software Suite 138 further includes Impact Analysis Module 230, 3D Visualization Module 250, Forecasting Module 220 and Model Library 210, as well as a clearinghouse hub module, discussed below.

Desktop GIS software and Impact Analysis, 3D Visualization, and Forecasting Modules are commercially available. For example, Environmental Systems Research Institute, Inc. (ESRI), in Redlands, California, markets ArcView, a Desktop GIS whose principle functions are viewing and querying spatial data. Other Desktop GIS products include Intergraph's GeoMedia and MapInfo Corporation's MapInfo Pro. Scenario Constructor is an Impact Analysis Module developed by the Orton Family Foundation, in Rutland, Vermont, that is a spatial impact analysis tool written in Avenue (ArcView's exclusive object-based language). Other Impact Analysis products include Columbia University's Smart Places, Criterion Inc.'s Smart Growth INDEX, and Community Analysis and Planning Systems, Inc.'s What If.? PSS. TownBuilder 3D is a real-time 3D Visualization Module written in C, C++, Visual Basic, and Avenue programming languages and developed by MultiGen-Paradigm, Inc., in San Jose, California. Other 3D Visualization products include Evans & Sutherland's RAPIDSite Producer and Terrex's Terra Vista. Policy Simulator is a Forecasting Module comprising an agent-based forecasting model written in the C, C++, Visual Basic, and Avenue programming languages and was designed and developed by PricewaterhouseCoopers, in New York, N.Y. Other forecasting products include UGROW developed by Prescott College. Those skilled in the art will recognize that these and other modules can be used in the present invention without departing from the spirit of the invention or the scope of the appended claims.

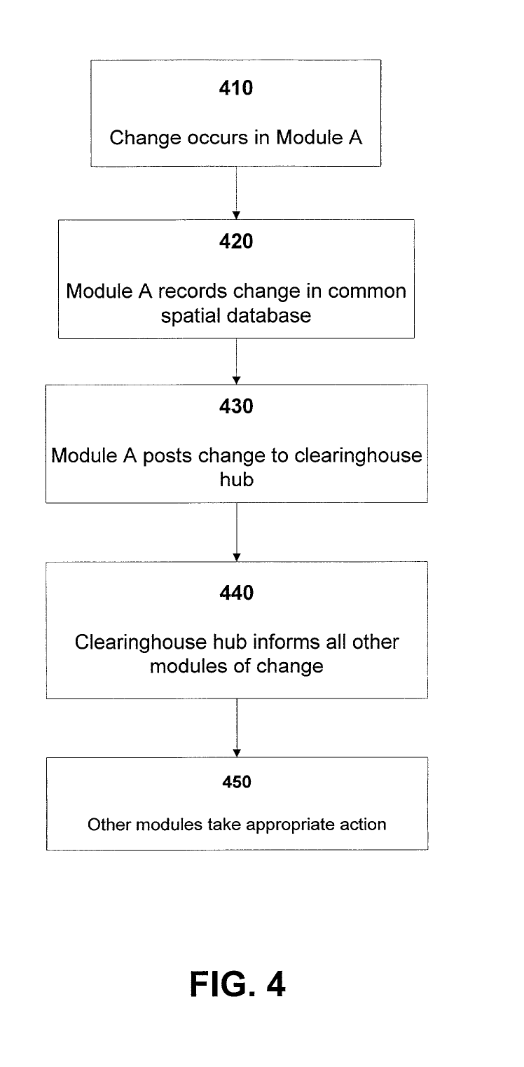

In operation, Integrated Software Suite 138 is installed on hard disk drive 130 as an extension of Desktop GIS 240, which includes 3D Visualization Module 250, Forecasting Module 220, Impact Analysis Module 230, and Model Library 210. There is data communication via Desktop GIS's spatial database 134 between Impact Analysis Module 230, 3D Visualization Module 250, and Forecasting Module 220, so that data modifications in one module may be reflected in the other modules. The method by which data modifications are reflected is described in the section below that refers to FIG. 4.

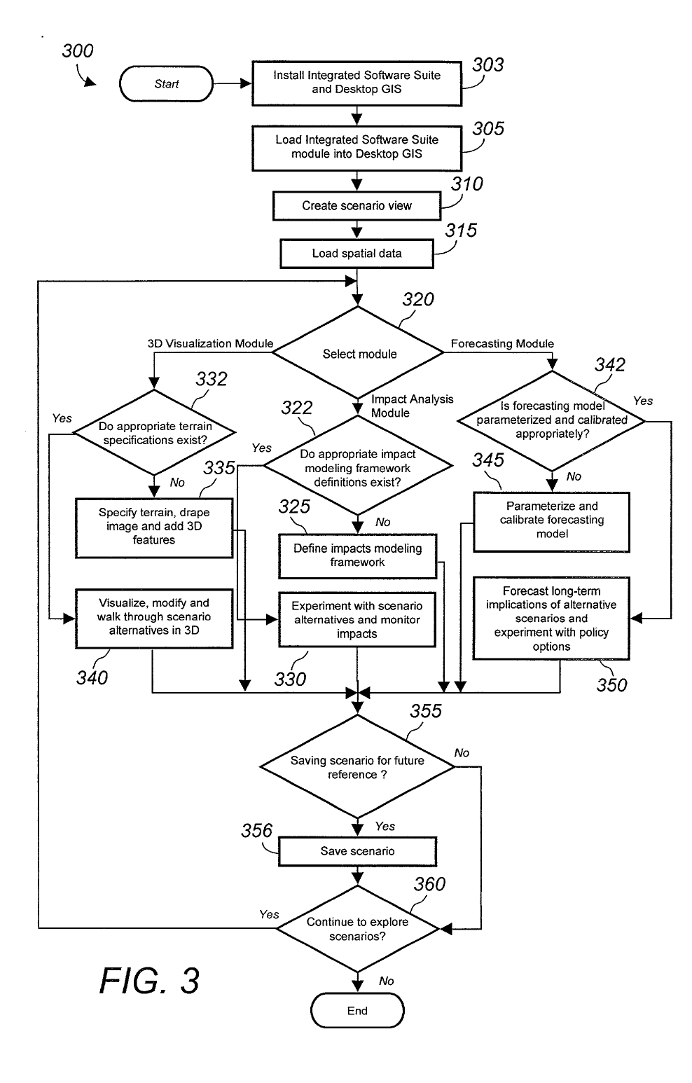

Process 300 is preferably executed using object-oriented computer programming, which allows a large number of step execution sequences. A preferred step execution sequence is shown in FIG. 3.

FIG. 3 illustrates an integrated method of supporting spatial decision-making and land-use scenario analysis, including the following steps:

Step 303 comprises installing Integrated Software Suite 138 and Desktop GIS 240. In this step, a technical user installs Desktop GIS 240 and Integrated Software Suite 138 onto hard disk drive 130 via CD-ROM drive 170. From the Integrated Software Suite 138, the user must choose to install those applications that are most applicable to the eventual use of the Integrated Software Suite 138. A complete installation of the Integrated Software Suite 138 includes Impact Analysis Module 230, 3D Visualization Module 250, Forecasting Module 220, and a Model Library 210. Model Library 210 preferably contains 3D features, such as trees, houses, street signs, etc.

Step 305 comprises loading Integrated Software Suite extensions (modules) into Desktop GIS 240. In this step, a technical user installs an Integrated Software Suite 138 extension into Desktop GIS 240. Desktop GIS 240 software architecture accepts the installation of other software modules, known as extensions. The Integrated Software Suite 138 is installed as an Desktop GIS 240 extension such that when Desktop GIS 240 is executed and the Integrated Software Suite 138 extension is activated, the corresponding Integrated Software Suite 138 modules appear as menu functions within the Desktop GIS 240 functionality. Loading Integrated Software Suite 138 into Desktop GIS 240 causes two results: (1) an Integrated Software Suite 138 menu appears that extends the user functionality of Desktop GIS 240, and (2) new document types become available, one of which is a scenario view (discussed below). The architecture for most commercially-available desktop GIS software products accepts installation of other software modules, commonly referred to as extensions.

Step 310 comprises creating a scenario view. In this step, a technical user who has knowledge of spatial modeling, Integrated Software Suite 138, and Desktop GIS 240, creates a Desktop GIS 240 map upon which spatial scenarios can be explored. For example, if a user wishes to explore scenarios associated with placing a shopping mall in Smalltown, U.S.A, a scenario view entitled Smalltown Mall could be created. This forms the basis upon which all future scenarios involving a shopping mall in Smalltown, U.S.A are performed. This is the empty framework upon which scenarios are explored.

Step 315 comprises loading spatial data. In this step, the technical user loads into Desktop GIS 240 GIS spatial data applicable to the geographic location and scenarios being explored. This data is preferably loaded from CD-ROM drive 170 and updates spatial database 134. For example, the user might load road systems, current building locations, river locations, etc. This data defines the geographic location, as it exists at the present time (e.g., present day Smalltown, U.S.A).

Step 320 comprises selecting an application. In this decision step, the technical user selects which of the Integrated Software Suite 138 modules should be set up first. This decision is based upon which application the user wishes to use and what function the user wishes to accomplish. If the technical user selects Impact Analysis Module 230, process 300 proceeds to step 325; if the technical user selects 3D Visualization Module 250, process 300 proceeds to step 335; if the technical user selects Forecasting Module 220, process 300 proceeds to step 345.

Step 322 comprises ascertaining whether appropriate impacts-modeling framework definitions exist. In this decision step, a land-use planner determines whether appropriate impacts-modeling framework definitions exist. If yes, then process 300 proceeds to step 330; if no, process 300 proceeds to 325. For an initial scenario creation, the technical user creates appropriate impacts-modeling framework definitions.

Step 325 comprises defining an impacts-modeling framework. In this step, the technical user defines the impacts for a modeling framework within Impact Analysis Module 230. This framework defines the modeling environment. During this process, the following relationships are typically defined: assumptions, constraints, causality relationships, and indicators. For example, if the user wishes to explore the traffic impacts of new development proposals, Impact Analysis Module 230 requires data, such as assumptions for traffic volumes from a new development, current traffic volume on existing roads, and apartment complex vs. single family unit traffic volume differentials. An example relationship could take the form: If an apartment building of X units is placed at a specific location, then a traffic volume of Y cars will appear on the highway.

Step 330 comprises experimenting with scenario alternatives and monitoring impacts. In this step, a land-use planner evaluates impacts of the scenario defined in steps 310 and 315, generates derivative scenarios by varying the placement of features, changing attributes, and changing assumptions. The land-use planner also evaluates the impacts of the derivative scenarios.

Each modification of the scenario data in Impact Analysis Module 230 is immediately reflected in other Integrated Software Suite 138 modules (in a preferred embodiment, 3D Visualization Module 250 and Forecasting Module 220). This is accomplished through the updating of spatial database 134 and the posting of events using integration protocols like dynamic data exchange (DDE) that alerts the other applications of a data change.

Each of the modules uses a common spatial-referencing system. While each of the modules produces results that are not necessarily spatial in nature (e.g., indicator results, building appearance, or projected tax revenues), every result is produced within a spatial context. The scope of the spatial context used by all modules is established by the geographic extent and content of the data layers loaded into the scenario view (see FIG. 3, step 315). This spatial environment is maintained, saved and retrieved as part of the scenario view (see FIG. 3, step 310).

Because all modules use a common spatial-referencing system, the other modules in the suite, without further translation, can immediately and meaningfully interpret the spatial implications that result due to experimentation in any other module.

For example, suppose the layout for a proposed Master Plan is recorded in the common spatial database 134. Forecasting Module 220 can be used to project new structures likely to be built over the next decade as a result of a proposed Master Plan. The spatial context for Forecasting Module 220's projection includes the locations (x-y coordinates) for each projected structure. These x-y coordinates are dynamically recorded in common spatial database 134.

3D Visualization Module 250 also functions within the context of spatial database 134 and can readily interpret the x-y coordinates. However, 3D Visualization Module 250 might add visual context to this simple x-y location by associating it with placement on a mountainous terrain and/or by associating 3-dimensional models with unique appearances from the Model Library 210 for each coordinate. This allows the user to “see” the projected future from the Forecasting Module 220. The visual “attributes” that are associated with the projected x-y coordinates are also dynamically recorded in common spatial database 134.

Impact Analysis Module 230 also functions within the context of the same spatial database and can readily interpret not only the x-y coordinates, but the significance of the 3-dimensional attributes as well. Impact Analysis Module 230 might use this information to further compute impacts on local resources or drainage patterns. Unacceptable impacts may cause the user to modify the proposed Master Plan. This new layout is recorded in the common spatial database 134. The process outlined above may repeat itself many times, providing the user with interactive, iterative, multi-objective analysis.

In a preferred embodiment, each module can “tag” any spatial data element with information specific to that module's integration requirements. The spatial database 134 used for establishing spatial context and results exchange between the modules of the suite is typical of any common GIS spatial database. Distinct map “layers” exist which define various spatial characteristics of a location (e.g., road systems, water features, soil types, building locations, tax zones, etc.). To enable efficient interpretation and reaction to changes within the layers by the individual modules of the suite, an additional data layer tagging architecture is used. Any module can tag any spatial data layer. Multiple tags can exist for any data layer.

These “auxiliary data” tags include context-specific metadata required for operation of each module. Examples of spatial layer data tags used within the suite are a Forecasting Module policy lookup table associated with a particular tax zone data layer or a 3D Visualization Module's last known viewing position and direction within a 3-dimensional scene.

Software maintenance links are provided as part of the auxiliary data tag management system. Any module linked to the software suite can dynamically update the auxiliary data tags index using maintenance functions such as AddTag, SetTag, GetTag, and RemoveTag. The index of auxiliary data tags for each spatial data layer is maintained, saved, and retrieved as part of a scenario view (see FIG. 3, step 310).

Each module responds dynamically to events posted by the other modules. In a preferred embodiment, each module has the capability to immediately reflect modifications made in other modules. The changes are recorded and exchanged via common spatial database 134, as described above. The automatic response to these changes between modules is enabled by an event-posting architecture comprised in Integrated Software Suite 138. This event-posting architecture is enabled by a common communication protocol such as DDE, OLE, or object-polling methodology. However, since the common exchange mechanism between modules of the suite is spatial, the events posted within this suite identify changes to the spatial context of the scenario. Also, events are multi-directional; any module can post an event to any other module. This multi-directional event posting is enabled by using an internal central clearinghouse module as a hub for posting of events. Each module posts its events to and “listens” for postings from the clearinghouse module. The clearinghouse module maintains the logic engine for appropriate responses to any posted event (updates impacts and/or posts subsequent events to other modules). Examples of events which might be posted by any module concerning feature changes within the spatial database include: FeatureAdded, FeatureDeleted, FeatureModified (size or location), and FeatureHighlighted.

Steps of the preferred method of integrating spatial decision-making and land-use scenario modules described above are illustrated in FIG. 4. At step 410, one of the modules (“Module A”) receives a data modification (“change”) to a scenario. This change typically occurs in steps 330, 340, or 350 (depending on which module happens to be “Module A”) (see FIG. 3) as the user is experimenting with scenario alternatives within the context of Module A. The change could also occur during steps 325, 335, or 345.

At step 420, Module A records the change in common spatial database 134. That is, the spatial implications of the change are recorded in common spatial database 134.

At step 430, Module A posts the change to the clearinghouse hub of Integrated Software Suite 138. That is, the clearinghouse hub is informed by Module A that a change has occurred to the scenario.

At step 440, the clearinghouse hub informs all other modules of the change. In this step. the clearinghouse hub immediately alerts all other modules that a scenario change has occurred.

At step 450, other modules take appropriate action. Each module responds to the alert received from the clearinghouse hub appropriately. A module's response to a change typically includes interpreting results recorded in the common spatial database 134.

Thus a preferred embodiment of the present invention comprises a method of providing a fully interactive and integrated planning tool in an integrated software suite for spatial decision making comprising spatial decision-making and land-use planning software modules wherein modifications made to land-use scenarios in one software module are immediately reflected in other modules, comprising the steps of: (a) enabling each module in the software suite to record each scenario data modification performed by that module in a common spatial database; (b) creating a clearinghouse hub that is capable of receiving notifications of scenario data modifications from each module and of immediately notifying all other modules of each scenario data modification; (c) enabling each module to immediately inform the clearinghouse hub of each scenario data modification performed by that module; and (d) enabling each module to respond to each notification of a scenario data modification received from the clearinghouse hub by immediately accessing the modified scenario data in the common spatial database.

In an alternate (system) embodiment, the present invention comprises an integrated software-based system for spatial decision making comprising: (a) a common spatial database; (b) a clearinghouse hub; and (c) a plurality of spatial decision-making and land-use planning software modules, wherein each module is operative to record in the common spatial database each scenario data modification performed by that module and operative to immediately inform the clearinghouse hub of each scenario data modification performed by that module; wherein the clearinghouse hub is operative to receive notifications of scenario data modifications from each of the modules and to immediately notify all other of the modules of each scenario data modification; and wherein each module is operative to respond to each notification of a scenario data modification received from the clearinghouse hub by immediately accessing the modified scenario data in the common spatial database.

Returning to FIG. 3, step 332 comprises ascertaining whether appropriate terrain specifications exist. In this decision step, the land-use planner determines if appropriate terrain specifications exist. If yes, then process 300 proceeds to step 340; if no, process 300 proceeds to 335. For an initial scenario creation, the technical user creates appropriate terrain specifications.

Step 335 comprises specifying terrain, draping an image, and adding 3D features. In this step, a technical user utilizes 3D Visualization Module 250 to update spatial database 134 with (1) terrain descriptions within a spatial data layer, (2) a satellite or aerial photograph draped over the geography, and (3) additional features, such as trees and buildings. Features can be static (unchangeable) or dynamic (changeable). This step results in a 3D virtual location, e.g., a fully viewable Smalltown, U.S.A. This virtual location can be navigated using mouse 160.

Step 340 comprises visualizing, modifying, and walking through scenario alternatives in 3D. In this step, a land-use planner visualizes on high-resolution display 140 the virtual location set up in step 335. The land-use planner may also alter, modify, or delete any dynamic feature. For example, the land-use planner may remove a tree or add a row of cars in front of a building. These changes are reflected in spatial database 134 and the other Integrated Software Suite 138 modules are alerted to the posted events, as described in step 330. The land-use planner may also navigate the virtual location from different perspectives (“flying” or “walking” through Smalltown, U.S.A, for example) using mouse 160. Navigation does not modify spatial database 134 but gives the land-use planner a sense of the visual impact of feature modifications. As with the other applications within Integrated Software Suite 138, changes to the scenario are reflected in spatial database 134, and the other Integrated Software Suite modules are alerted to the posted events through integration software, as discussed with respect to FIG. 4.

Step 342 comprises ascertaining whether the forecasting model in Forecasting Module 220 is parametrized and calibrated appropriately. In this decision step, the land-use planner determines whether the forecasting model is parametrized and calibrated appropriately. If yes, process 300 proceeds to step 350; if no, process 300 proceeds to 345. For an initial scenario creation, the technical user parametrizes and calibrates the forecasting model.

Step 345 comprises parametrizing and calibrating the forecasting model. In this step, a technical user parametrizes the Forecasting Module 220 forecasting model by entering current policies, population, zoning, census data, eaming parameters within the virtual location of the scenario view created in step 310. Ideally, parameters are entered for two time periods: (1) the present time and (2) sometime in history when this data was known. The technical user then calibrates the forecasting model by testing its predictions against changes that actually occurred over the given stated period. For example, the real-world changes within the time period 1990- 2000 could be used to confirm the predictions of the forecasting model for that same time period. If the forecasting model does not accurately predict the real-world changes, the parameters are adjusted until the model predicts changes accurately.

Step 350 comprises forecasting long-term implications of alternative scenarios and experimenting with policy options. In this step, the land-use planner executes a simulation by running the Forecasting Module 220 forecasting model over a given time period with no policy changes. For example, the land-use planner may wish to know how Smalltown, U.S.A will appear ten years from the present date given the current policies. The land-use planner may then make modifications to current policies, run the forecasting model again, and view characteristics (population, structure location, land values, etc.) of Smalltown, U.S.A ten years in the future, given these changes. For example, the land-use planner may modify a zoning policy to reflect a much larger commercial zoning area in Smalltown, U.S.A and then see how this change affects the future characteristics of the town. As with the other applications within Integrated Software Suite, changes in policies and parameters are reflected in spatial database 134, and the other Integrated Software Suite applications are alerted to the posted events through integration software, as discussed with respect to FIG. 4.

In step 355, the land-use planner determines whether to save the current land-use scenario to hard disk drive 130 for future reference. If yes, process 300 proceeds to step 356; if no, process 300 proceeds to 360. In step 356, the land-use planner saves the current scenario to hard disk drive 130. In step 360, the land-use planner decides whether to continue exploring land-use scenarios. If yes, process 300 returns to step 320; if no, process 300 ends.

While the embodiments shown and described herein are fully capable of achieving the objects of the subject invention, it is evident that numerous alternatives, modifications, and variations will be apparent to those skilled in the art in light of the foregoing description. These alternatives, modifications, and variations are within the scope of the subject invention, and it is to be understood that the embodiments described herein are shown only for the purpose of illustration and not for the purpose of limitation.

What is claimed is:

1. A method of providing a fully interactive and integrated planning tool in an integrated software suite for spatial decision making comprising spatial decision-making and land-use planning software modules wherein modifications made to land-use scenarios in one software module are immediately reflected in other modules, comprising the steps of:
(a) enabling each module in the software suite to record each scenario data modification performed by that module in a common spatial database;
(b) creating a clearinghouse hub that is capable of receiving notifications of scenario data modifications from each module and of immediately notifying all other modules of each scenario data modification;
(c) enabling each module to immediately inform said clearinghouse hub of each scenario data modification performed by that module; and
(d) enabling each module to respond to each notification of a scenario data modification received from said clearinghouse hub by immediately accessing the modified scenario data in said common spatial database.

2. The method of claim 1, wherein said software suite is integrated with a desktop GIS.

3. The method of claim 1, wherein said software suite comprises an impact analysis module.

4. The method of claim 1, wherein said software suite comprises a 3D visualization module.

5. The method of claim 1, wherein said software suite comprises a forecasting module.

6. An integrated software-based system for spatial decision making comprising:
(a) a common spatial database;
(b) a clearinghouse hub; and
(c) a plurality of spatial decision-making and land-use planning software modules, wherein each module is operative to record in said common spatial database each scenario data modification performed by that module and operative to immediately inform said clearinghouse hub of each scenario data modification performed by that module;
wherein said clearinghouse hub is operative to receive notifications of scenario data modifications from each of said modules and to immediately notify all other of said modules of each scenario data modification; and
wherein each module is operative to respond to each notification of a scenario data modification received from said clearinghouse hub by immediately accessing the modified scenario data in said common spatial database.

7. The system of claim 6, further comprising an integrated desktop GIS.

8. The system of claim 6, wherein said plurality of spatial decision-making and land-use planning software modules comprises an impact analysis module.

9. The system of claim 6, wherein said plurality of spatial decision-making and land-use planning software modules comprises a 3D visualization module.

10. The system of claim 6, wherein said plurality of spatial decision-making and land-use planning software modules comprises a forecasting module.
